(19) United States
(12) Patent Application Publication
(10) Pub. No.: US 2007/0169898 A1
(43) Pub. Date: Jul. 26, 2007

(54) Cord guide mechanism of winding device for Venetian blind

(76) Inventor: Ke-Min Lin, Jiayi (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/339,756

(22) Filed: Jan. 25, 2006

(51) Int. Cl. E06B 9/30

(52) U.S. Cl. 160/171

(57) ABSTRACT

A winding device for a Venetian blind includes a winding rod for winding and unwinding at least one pull cord, and a cord guide mechanism mounted on the winding rod and having a cord guide hole parallel with the winding rod. Thus, the pull cord is wound around the winding rod in a parallel manner, so that the pull cord is not deflected, overlapped or tangled on the winding rod during the winding process due to a vibration produced by the pulling force of the winding device, and the pull cord is in turn wound around the winding rod smoothly and evenly.

### BACKGROUND OF THE INVENTION

1. Field of the Invention

The present invention relates to a cord guide mechanism and, more particularly, to a cord guide mechanism of a winding device for a window covering, such as the Venetian blind and the like.

2. Description of the Related Art

A conventional Venetian blind in accordance with the prior art shown in FIG. 9 comprises a headrail 9, a plurality of laths 71 attached to the headrail 9, at least one pull cord 7 (preferably two pull cords) extended through each of the laths 71 to lift or lower the laths 71, and a winding device 8 mounted on the headrail 9 to wind or unwind the at least one pull cord 7 so as to lift or lower the laths 71. The winding device 8 comprises a winding rod 81 rotatably mounted on the headrail 9 for winding and unwinding the at least one pull cord 7. However, when the at least one pull cord 7 is wound around the winding rod 81, the at least one pull cord 7 is easily deflected, overlapped or tangled on the winding rod 81 during the winding process due to a vibration produced by the pulling force of the winding device 8, so that the at least one pull cord 7 is not wound around the winding rod 81 smoothly and evenly, thereby causing inconvenience to a user in operation of the winding device 8.

### SUMMARY OF THE INVENTION

In accordance with the present invention, there is provided a winding device for a Venetian blind, comprising a winding rod, and a cord guide mechanism mounted on the winding rod and having a cord guide hole parallel with the winding rod.

The primary objective of the present invention is to provide a winding device having a cord guide mechanism to guide the pull cords of the Venetian blind.

Another objective of the present invention is to provide a winding device, wherein the at least one pull cord is wound around the winding rod in a parallel manner, so that the at least one pull cord is not deflected, overlapped or tangled on the winding rod during the winding process due to a vibration produced by the pulling force of the winding device, and the at least one pull cord is in turn wound around the winding rod smoothly and evenly.

A further objective of the present invention is to provide a winding device, wherein the cord guide hole of the cord guide mechanism is located adjacent to the winding rod, so that the at least one pull cord protruded outward from the cord guide hole of the cord guide mechanism will push the wound portion of the at least one pull cord, and the at least one pull cord is wound around the winding rod smoothly, thereby facilitating operation of the winding device.

Further benefits and advantages of the present invention will become apparent after a careful reading of the detailed description with appropriate reference to the accompanying drawings.

### BRIEF DESCRIPTION OF THE DRAWINGS

FIG. 1 is a partially plan cross-sectional view of a Venetian blind in accordance with the preferred embodiment of the present invention.

FIG. 2 is a perspective view of a cord guide mechanism of the Venetian blind as shown in FIG. 1.

FIG. 3 is a perspective view of a cord guide mechanism of a Venetian blind in accordance with another preferred embodiment of the present invention.

FIG. 4 is a partially plan cross-sectional view of a Venetian blind in accordance with another preferred embodiment of the present invention.

FIG. 5 is a perspective view of a cord guide mechanism of the Venetian blind as shown in FIG. 4.

FIG. 6 is a perspective view of a cord guide mechanism of a Venetian blind in accordance with another preferred embodiment of the present invention.

FIG. 7 is a partially plan cross-sectional view of a Venetian blind in accordance with another preferred embodiment of the present invention.

FIG. 8 is a perspective view of a cord guide mechanism of the Venetian blind as shown in FIG. 7.

FIG. 9 is a partially plan cross-sectional view of a conventional Venetian blind in accordance with the prior art.

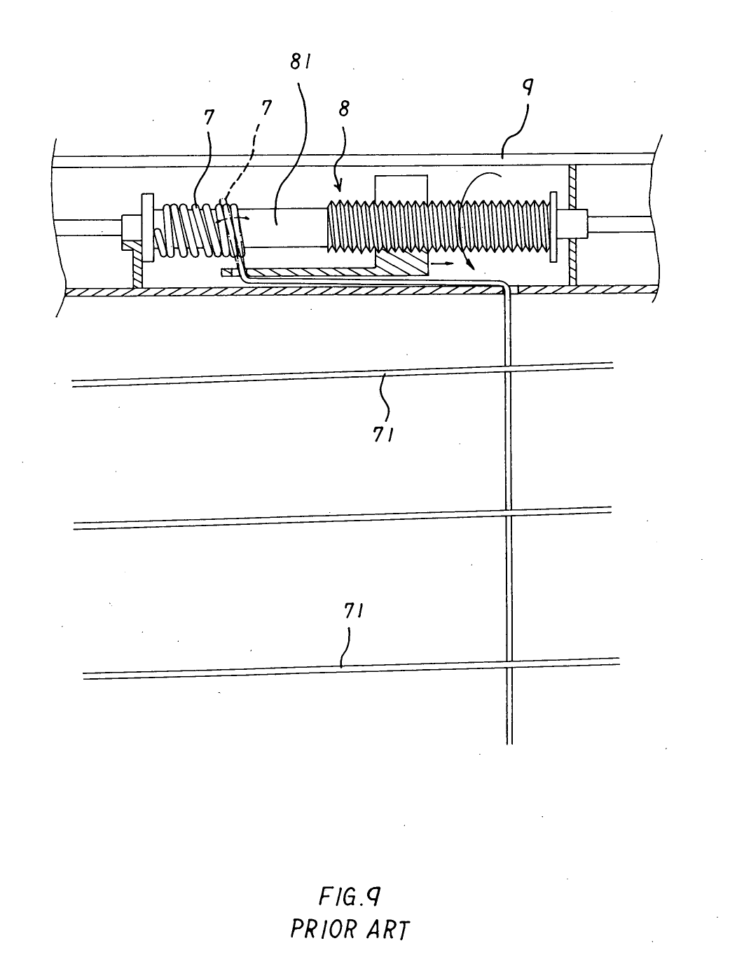

### DETAILED DESCRIPTION OF THE INVENTION

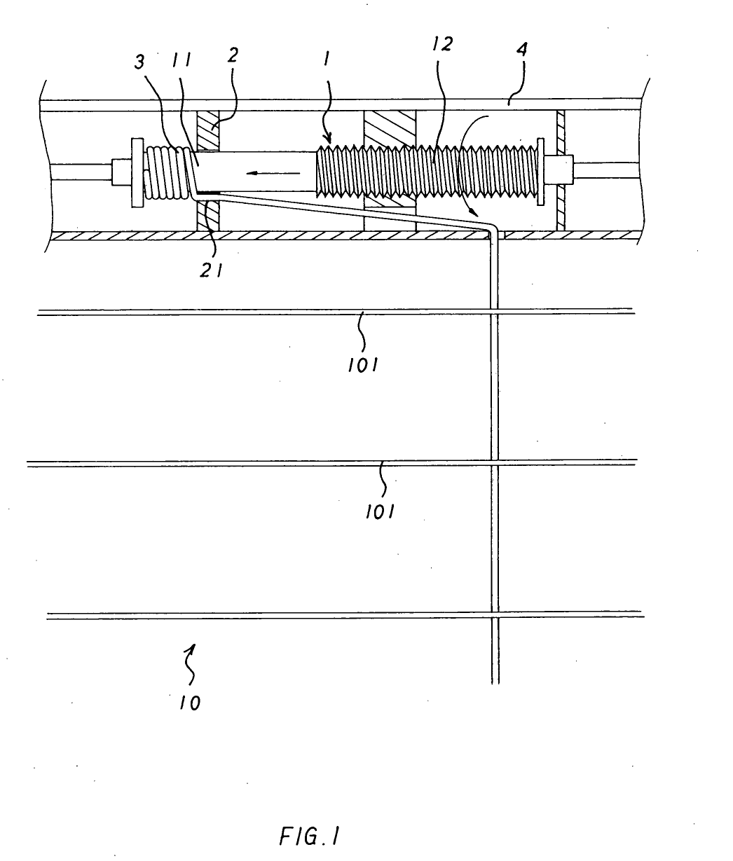

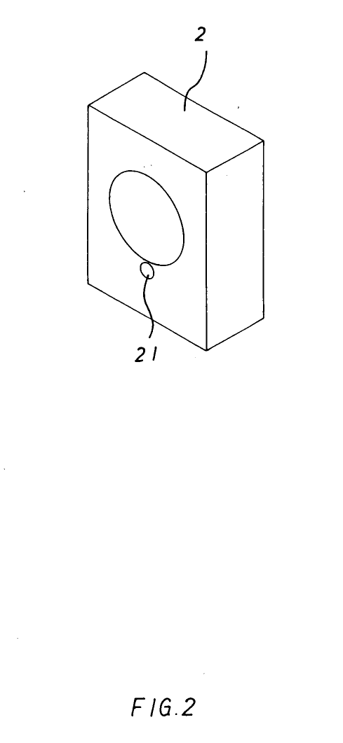

Referring to the drawings and initially to FIGS. 1 and 2, a Venetian blind 10 in accordance with the preferred embodiment of the present invention comprises a headrail 4, a plurality of laths 101 attached to the headrail 4, at least one pull cord 3 (preferably two pull cords) extended through each of the laths 101 to lift or lower the laths 101, and a winding device 1 mounted on the headrail 4 to wind or unwind the at least one pull cord 3 so as to lift or lower the laths 101.

The winding device 1 comprises a winding rod 11 rotatably and movably mounted on the headrail 4, and a cord guide mechanism 2 mounted on the winding rod 11 and having a cord guide hole 21 parallel with the winding rod 11. The winding rod 11 is axially movable relative to the cord guide mechanism 2, and the cord guide mechanism 2 is secured to the headrail 4. The at least one pull cord 3 has a distal end extended through and protruded outward from the cord guide hole 21 of the cord guide mechanism 2 and secured to the winding rod 11 to rotate therewith.

In such a manner, the at least one pull cord 3 is wound around the winding rod 11 in a parallel manner, so that the at least one pull cord 3 is not deflected, overlapped or tangled on the winding rod 11 during the winding process due to a vibration produced by the pulling force of the winding device 1, and the at least one pull cord 3 is in turn wound around the winding rod 11 smoothly and evenly.

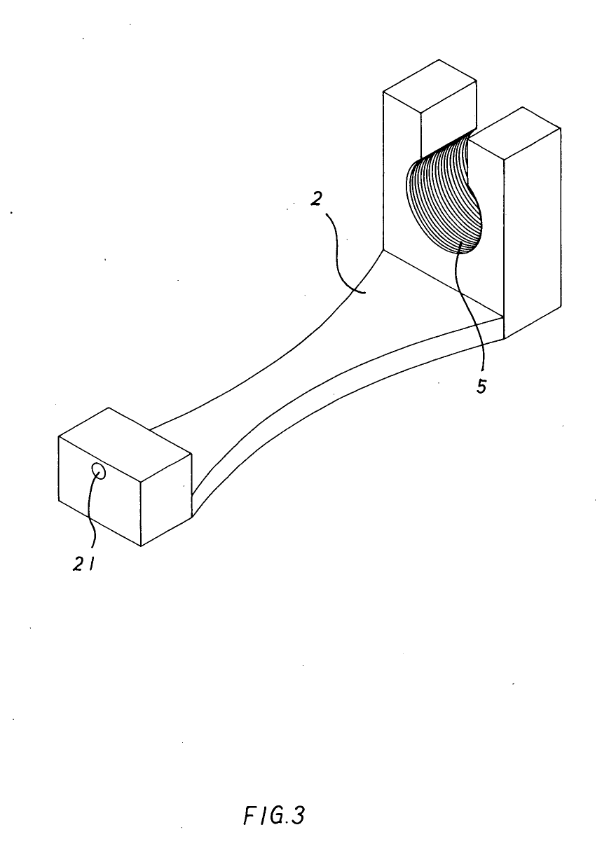

As shown in FIG. 3, the cord guide mechanism 2 is connected to a threaded bushing 5, and the winding rod 11 has a threaded portion 12 movably mounted in the threaded bushing 5 so that the winding rod 11 is axially movable relative to the cord guide mechanism 2.

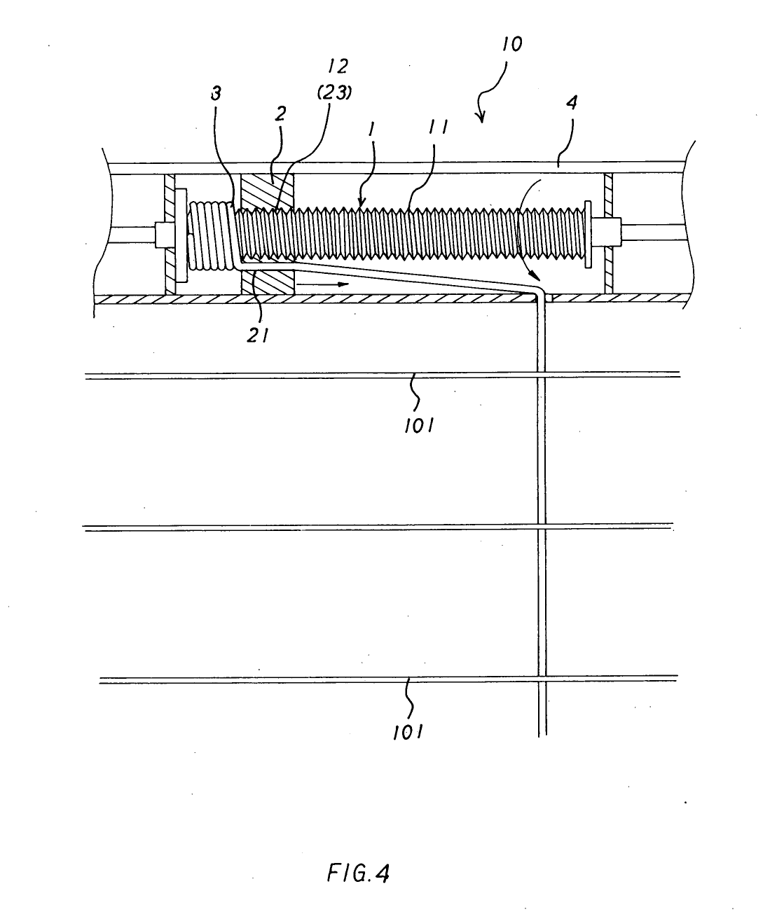

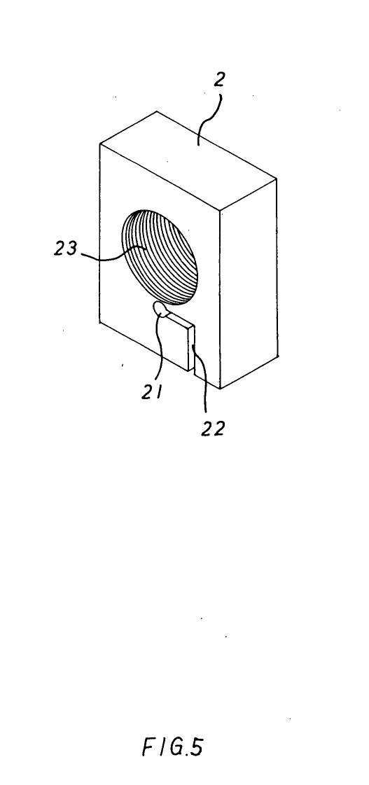

As-shown in FIGS. 4 and 5, the cord guide mechanism 2 has a screw bore 23 screwed onto the threaded portion 12 of the winding rod 11 so that the winding rod 11 is axially movable relative to the cord guide mechanism 2. The cord guide hole 21 of the cord guide mechanism 2 is formed with an opening 22, and the at least one pull cord 3 is directly inserted through the opening 22 into the cord guide hole 21 of the cord guide mechanism 2.

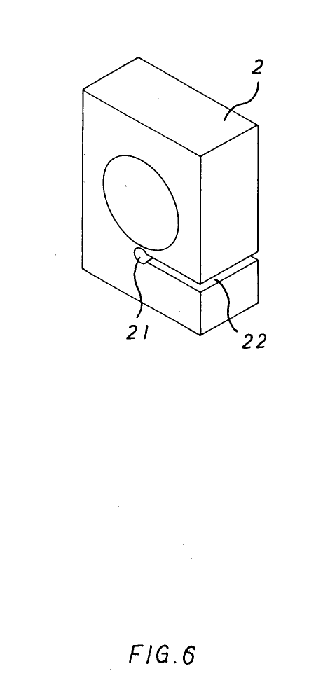

As shown in FIG. 6, the opening 22 of the cord guide hole 21 of the cord guide mechanism 2 has a different shape.

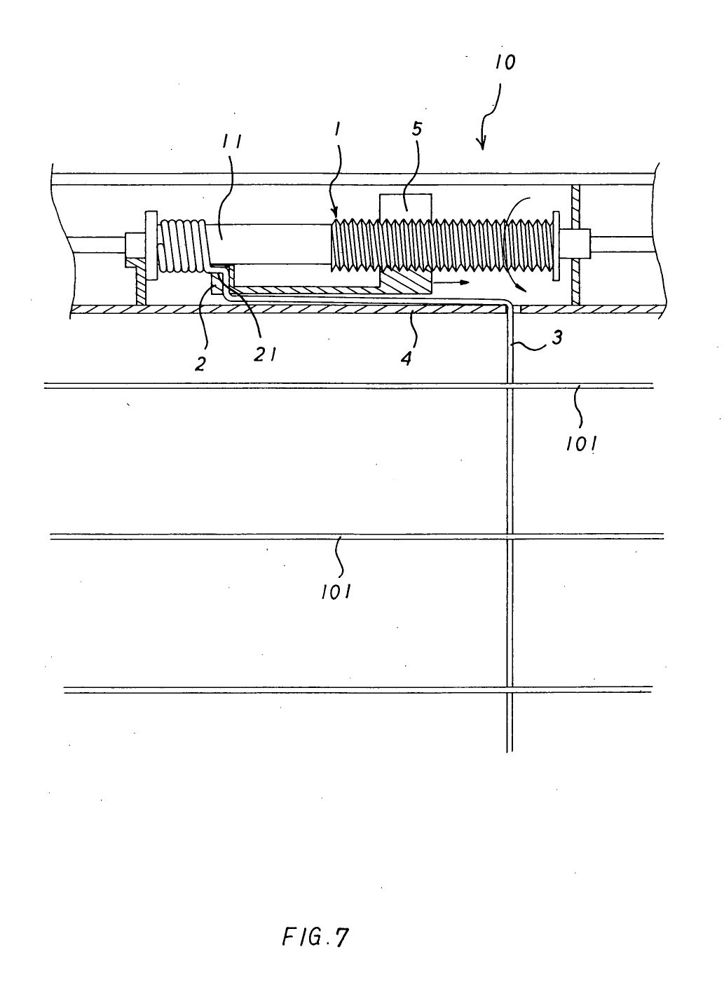

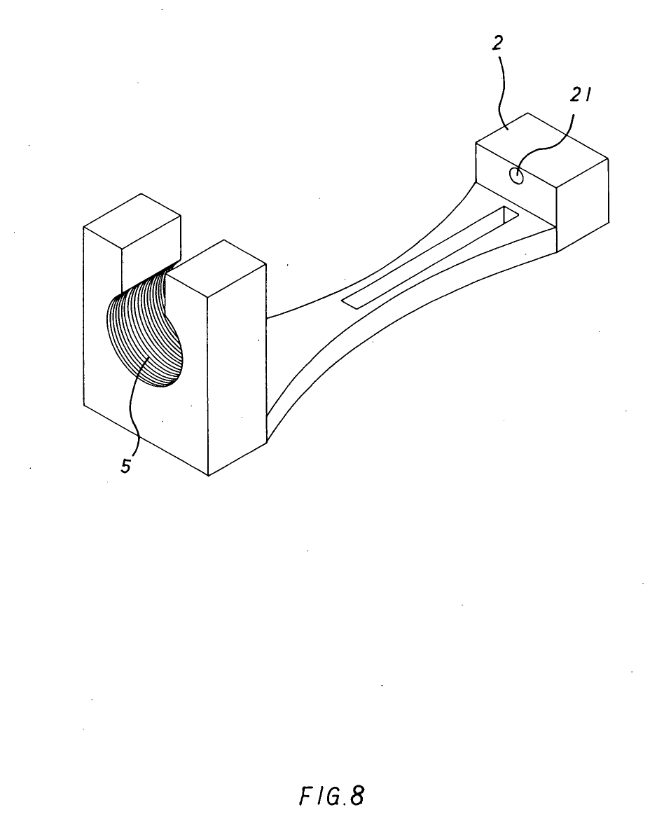

As shown in FIGS. 7 and 8, the cord guide mechanism 2 is located adjacent to a connection of the at least one pull cord 3 and the winding rod 11, so that after the at least one pull cord 3 is protruded outward from the cord guide hole 21 of the cord guide mechanism 2, the at least one pull cord 3 is wound around the winding rod 11 immediately and will not depend in the air, thereby prevent the at least one pull cord 3 from being deflected, overlapped or tangled on the winding rod 11 during the winding process due to a vibration produced by the pulling force of the winding device 1.

Further, the cord guide hole 21 of the cord guide mechanism 2 is located adjacent to the winding rod 11, and the distance between the cord guide hole 21 of the cord guide mechanism 2 and the winding rod 11 is smaller than the diameter of the at least one pull cord 3 to prevent the at least one pull cord 3 from being tangled or overlapped. Preferably, the distance between the cord guide hole 21 of the cord guide mechanism 2 and the winding rod 11 is smaller than half of the diameter of the at least one pull cord 3. Thus, the at least one pull cord 3 protruded outward from the cord guide hole 21 of the cord guide mechanism 2 will push the wound portion of the at least one pull cord 3, so that the at least one pull cord 3 is wound around the winding rod 11 smoothly, thereby facilitating operation of the winding device 1.

Accordingly, the at least one pull cord 3 is wound around the winding rod 11 in a parallel manner, so that the at least one pull cord 3 is not deflected, overlapped or tangled on the winding rod 11 during the winding process due to a vibration produced by the pulling force of the winding device 1, and the at least one pull cord 3 is in turn wound around the winding rod 11 smoothly and evenly. In addition, the cord guide hole 21 of the cord guide mechanism 2 is located adjacent to the winding rod 11, so that the at least one pull cord 3 protruded outward from the cord guide hole 21 of the cord guide mechanism 2 will push the wound portion of the at least one pull cord 3, and the at least one pull cord 3 is wound around the winding rod 11 smoothly, thereby facilitating operation of the winding device 1.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A winding device for a Venetian blind, comprising:
a winding rod;
a cord guide mechanism mounted on the winding rod and having a cord guide hole parallel with the winding rod.

2. The winding device in accordance with claim 1, wherein the cord guide mechanism is located adjacent to a connection of at least one pull cord and the winding rod.

3. The winding device in accordance with claim 2, wherein the cord guide mechanism is secured to a headrail, and the winding rod is axially movable relative to the cord guide mechanism when the at least one pull cord is wound around the winding rod.

4. The winding device in accordance with claim 2, wherein the cord guide mechanism is connected to a threaded bushing, and the winding rod has a threaded portion movably mounted in the threaded bushing so that the winding rod is axially movable relative to the cord guide mechanism.

5. The winding device in accordance with claim 1, wherein the cord guide hole of the cord guide mechanism is located adjacent to the winding rod.

6. The winding device in accordance with claim 2, wherein a distance between the cord guide hole of the cord guide mechanism and the winding rod is smaller than a diameter of the at least one pull cord.

7. The winding device in accordance with claim 2, wherein the cord guide hole of the cord guide mechanism is formed with an opening, and the at least one pull cord is directly inserted through the opening into the cord guide hole of the cord guide mechanism.

8. The winding device in accordance with claim 2, wherein the at least one pull cord has a distal end extended through and protruded outward from the cord guide hole of the cord guide mechanism and secured to the winding rod to rotate therewith.

9. The winding device in accordance with claim 2, wherein the at least one pull cord is wound around the winding rod in a parallel manner.

10. The winding device in accordance with claim 1, wherein the winding rod has a threaded portion, and the cord guide mechanism has a screw bore screwed onto the threaded portion of the winding rod so that the winding rod is axially movable relative to the cord guide mechanism.
